(19) United States
(12) Patent Application Publication
(10) Pub. No.: US 2016/0084649 A1
(43) Pub. Date: Mar. 24, 2016

(54) ELEVATOR SHAFT INNER DIMENSION MEASURING DEVICE, ELEVATOR SHAFT INNER DIMENSION MEASUREMENT CONTROLLER, AND ELEVATOR SHAFT INNER DIMENSION MEASUREMENT METHOD

(71) Applicant: Kabushiki Kaisha Toshiba, Tokyo (JP)

(72) Inventors: Masaki YAMAZAKI, Tokyo (JP); Akihito SEKI, Yokohama (JP); Ryuzo OKADA, Kawasaki (JP)

(21) Appl. No.: 14/854,496

(22) Filed: Sep. 15, 2015

(30) Foreign Application Priority Data
Sep. 19, 2014 (JP) 2014-191085

(51) Int. Cl. G01C 3/00; H04N 7/18

(52) U.S. Cl. CPC G01C 3/00; H04N 7/181

(57) ABSTRACT

According to one embodiment, an elevator shaft inner dimension measuring device includes a distance measuring instrument, an imaging device and a controller. The distance measuring instrument includes a first laser rangefinder mounted to a moving object moving through an interior of an elevator shaft, and irradiating laser light on an inner wall of the elevator shaft. The imaging device includes a first camera mounted to the moving object, and imaging the interior of the elevator shaft. The controller includes a calculator, a position calculating device, and a memory device. The calculator performs an operation on distance data obtained from the distance measuring instrument, and image data obtained from the imaging device. The position calculating device estimates a motion of the moving object and calculates a position of the moving object in the interior of the elevator shaft. The memory device stores the distance data and the image data.

### CROSS-REFERENCE TO RELATED APPLICATIONS

This application is based upon and claims the benefit of priority from Japanese Patent Application No. 2014-191085, filed on Sep. 19, 2014; the entire contents of which are incorporated herein by reference.

### FIELD

Embodiments described herein relate generally to an elevator shaft inner dimension measuring device, an elevator shaft inner dimension measurement controller, and an elevator shaft inner dimension measurement method.

### BACKGROUND

In the preparation stages when performing the replacement or repair of an elevator, work is performed to ascertain conditions inside the elevator shaft and measure the dimensions of the parts inside the elevator shaft necessary to make drawings. The work is performed by an operator entering the elevator shaft and measuring the dimensions using a tape measure, etc.

However, because the operator performs the work by measuring the dimensions while riding on the elevator car, for example, time and labor are necessary in the case where the measurement distance is relatively long, etc.

It is desirable to measure the dimensions inside the elevator shaft relatively easily or in a relatively short period of time.

### BRIEF DESCRIPTION OF THE DRAWINGS

FIG. 1 is a block diagram showing an elevator shaft inner dimension measuring device according to an embodiment;

FIG. 2 is a flowchart describing the elevator shaft inner dimension measurement method according to the embodiment;

FIG. 3 is a schematic plan view showing the elevator shaft inner dimension measuring device according to the embodiment;

FIG. 4 is a schematic plan view showing a modification of the mounting method of the elevator shaft inner dimension measuring device;

FIG. 5 is a schematic plan view showing another modification of the mounting method of the elevator shaft inner dimension measuring device;

FIG. 6 is a schematic plan view showing another modification of the mounting method of the elevator shaft inner dimension measuring device;

FIG. 7A to FIG. 7C are schematic plan views showing examples of the projection region of the irradiation region of the laser light projected onto the image that is imaged;

FIG. 8A and FIG. 8B are schematic views showing examples of motion estimation charts of the first camera;

FIG. 9A and FIG. 9B are schematic views showing another example of motion estimation charts of the first camera;

FIG. 10 is a schematic view showing an example of a scale estimation chart of the first laser rangefinder;

FIG. 11 is a schematic plan view showing an elevator shaft inner dimension measuring device according to another embodiment;

FIG. 12 is a block diagram showing an elevator shaft inner dimension measuring device according to a modification of the embodiment;

FIG. 13A and FIG. 13B are schematic plan views showing rotation states of the laser rangefinder;

FIG. 14A and FIG. 14B are schematic plan views showing other rotation states of the laser rangefinder;

FIG. 15 is a block diagram showing an elevator shaft inner dimension measuring device according to one other embodiment;

FIG. 16 is a flowchart describing an elevator shaft inner dimension measurement method according to the one other embodiment;

FIG. 17 is a schematic plan view showing the elevator shaft inner dimension measuring device according to the one other embodiment;

FIG. 18 is a schematic plan view showing an elevator shaft inner dimension measuring device according to another embodiment;

FIG. 19 is a block diagram showing an elevator shaft inner dimension measuring device according to a modification of the embodiment;

FIG. 20A and FIG. 20B are schematic plan views showing rotation states of the laser rangefinder; and

FIG. 21A and FIG. 21B are schematic plan views showing other rotation states of the laser rangefinder.

### DETAILED DESCRIPTION

According to one embodiment, an elevator shaft inner dimension measuring device includes a distance measuring instrument, an imaging device and a controller. The distance measuring instrument includes a first laser rangefinder. The first laser rangefinder is mounted to a moving object moving through an interior of an elevator shaft, and irradiates laser light on an inner wall of the elevator shaft. The imaging device includes a first camera. The first camera is mounted to the moving object, and images the interior of the elevator shaft. The controller includes a calculator, a position calculating device, and a memory device. The calculator performs an operation on distance data and image data. The distance data is obtained from the distance measuring instrument, and the image data is obtained from the imaging device. The position calculating device estimates a motion of the moving object based on the image data and calculates a position of the moving object in the interior of the elevator shaft based on the distance data. The memory device stores the distance data and the image data.

According to another embodiment, an elevator shaft inner dimension measurement controller includes a calculator, a position calculating device and a memory device. The calculator performs an operation on distance data and image data. The distance data is obtained from a distance measuring instrument including a laser rangefinder mounted to a moving object moving through an interior of an elevator shaft. The laser rangefinder irradiates laser light on an inner wall of the elevator shaft. The image data is obtained from an imaging device including a first camera mounted to the moving object. The first camera images the interior of the elevator shaft. The position calculating device estimates a motion of the moving object based on the image data and calculates a position of the moving object in the interior of the elevator shaft based on the distance data. The memory device stores the distance data and the image data.

According to another embodiment, an elevator shaft inner dimension measurement method includes performing an operation on distance data and image data. The distance data is obtained from a distance measuring instrument including a laser rangefinder mounted to a moving object moving through an interior of an elevator shaft. The laser rangefinder irradiates laser light on an inner wall of the elevator shaft. The image data is obtained from an imaging device including a first camera mounted to the moving object. The first camera images the interior of the elevator shaft. The method includes estimating a motion of the moving object based on the image data and calculating a position of the moving object in the interior of the elevator shaft based on the distance data. The method includes storing the distance data and the image data.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even in the case where the same portion is illustrated.

In the drawings and the specification of the application, components similar to those described in regard to a drawing thereinabove are marked with like reference numerals, and a detailed description is omitted as appropriate.

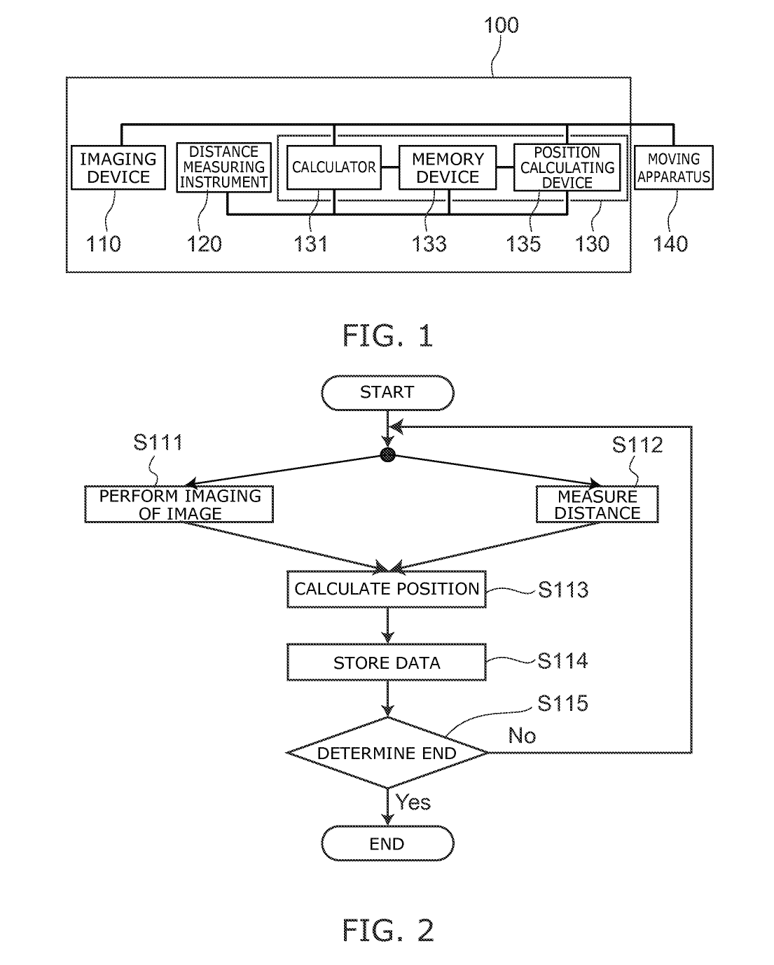

FIG. 1 is a block diagram showing an elevator shaft inner dimension measuring device according to an embodiment. FIG. 2 is a flowchart describing the elevator shaft inner dimension measurement method according to the embodiment.

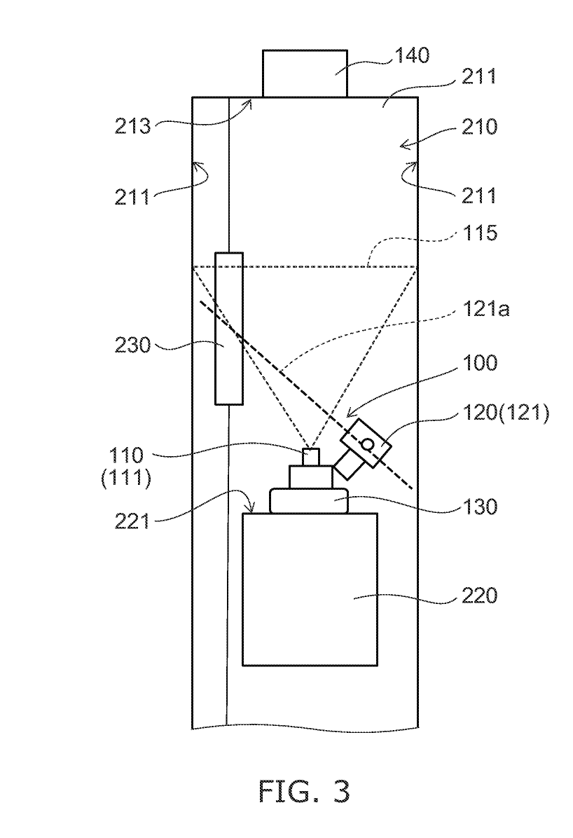

FIG. 3 is a schematic plan view showing the elevator shaft inner dimension measuring device according to the embodiment.

The block diagram shown in FIG. 1 is an example of the relevant components of the elevator shaft inner dimension measuring device according to the embodiment and does not necessarily match the configuration of the actual program module.

The elevator shaft inner dimension measuring device 100 includes an imaging device 110, a distance measuring instrument 120, and a controller (an elevator shaft inner dimension measurement controller) 130. The controller 130 corresponds to the elevator shaft inner dimension measurement controller according to the embodiment. The controller 130 includes a calculator 131, a memory device 133, and a position calculating device 135.

The controller 130 may be an external device that is different from the elevator shaft inner dimension measuring device 100 or may be a device included in the elevator shaft inner dimension measuring device 100. The hardware configuration shown in FIG. 1 is an example; and a portion of the controller 130 or the entire controller 130 according to the embodiments and the specific examples may be realized as an integrated circuit such as LSI (Large Scale Integration), etc., or an IC (Integrated Circuit) chipset. Each functional block may be provided with processing features individually; or some or all of the functional blocks may be provided with a processing feature by being integrated. The integrated circuit is not limited to LSI and may be realized using a dedicated circuit or a general-purpose processor.

A moving apparatus 140 is provided in at least one of the interior of an elevator shaft 210 or outside the elevator shaft 210. The moving apparatus 140 moves a moving object in the interior of the elevator shaft 210 in two directions (e.g., vertical directions or perpendicular directions). The moving object is, for example, an elevator car 220. Or, the moving object is, for example, a counterweight 230. However, the moving object is not limited to the elevator car 220 or the counterweight 230. In the example shown in FIG. 3, the elevator shaft inner dimension measuring device 100 is mounted to an upper portion 221 of the elevator car 220.

The imaging device 110 includes a first camera 111 and images an inner wall 211 of the elevator shaft 210. A digital camera that can receive visible light, a digital camera that can receive infrared light, etc., are examples of the first camera 111.

The distance measuring instrument 120 includes a first laser rangefinder 121 and irradiates laser light toward the inner wall 211 of the elevator shaft 210 inside a first field of view (an imaging range) 115 of the imaging device 110. A time-difference laser rangefinder, a phase-difference laser rangefinder, etc., are examples of the first laser rangefinder 121. The time-difference laser rangefinder calculates the distance between the laser rangefinder and a measurement object by measuring the time from when the laser light is irradiated to when the laser light is reflected by the measurement object and returns to the laser rangefinder. The phase-difference laser rangefinder determines the distance between the laser rangefinder and the measurement object by irradiating laser light modulated into a plurality and by performing the determination based on the phase difference of the diffuse reflection component of the laser light that strikes the measurement object and returns to the laser rangefinder. Or, laser rangefinders can be classified based on the angle in which the laser light can be irradiated. A horizontal laser and a two-dimensional laser are examples of the first laser rangefinder 121. The horizontal laser can irradiate laser light in a complete circle of 360 degrees in the horizontal direction. In other words, the horizontal laser can irradiate the laser light in a complete circle of 360 degrees around an axis of the movement direction of the moving object. The two-dimensional laser can irradiate the laser light horizontally and perpendicularly in a constant irradiation range.

The calculator 131 performs operations on the data acquired from the imaging device 110 and the data acquired from the distance measuring instrument 120. The calculator 131 also controls the imaging device 110 and the distance measuring instrument 120.

The memory device 133 stores the data acquired from the imaging device 110 and the data acquired from the distance measuring instrument 120.

The position calculating device 135 calculates the position of the moving object (the example of FIG. 3, the elevator car 220) in the interior of the elevator shaft 210 based on the image data obtained from the imaging device 110 and the distance data obtained from the distance measuring instrument 120.

The moving apparatus 140 moves the elevator car 220 in the interior of the elevator shaft 210.

The processing of the elevator shaft inner dimension measuring device 100 according to the embodiment will now be described. Here, an example will be described in which the moving object is the elevator car 220 as shown in FIG. 3.

As shown in FIG. 2, the imaging device 110 images the range (the first field of view 115) in the travel direction of the elevator car 220 (step S111).

More specifically, the imaging device 110 images the interior of the elevator shaft 210 to acquire an image (step S111). The imaging device 110 is mounted to the elevator car 220 inside the elevator shaft 210.

The calibration of calculating the focal length of the first camera 111, etc., the calibration of calculating the positional relationship (the rotation and the translation) between the imaging device 110 and the distance measuring instrument 120, etc., are performed beforehand. For example, the calibration method between the imaging device 110 and the distance measuring instrument 120 is as described in the reference document “Reliable Automatic Camera-Laser Calibration (Australasian Conference on Robotics and Automation 2010),” etc.

As shown in FIG. 3, in the case where the elevator shaft inner dimension measuring device 100 is mounted to the upper portion 221 of the elevator car 220, the imaging device 110 images the upper range of the elevator shaft 210 from the upper portion 221 of the elevator car 220 in the direction toward a ceiling 213 of the elevator shaft 210.

Modifications of the mounting method of the elevator shaft inner dimension measuring device will now be described.

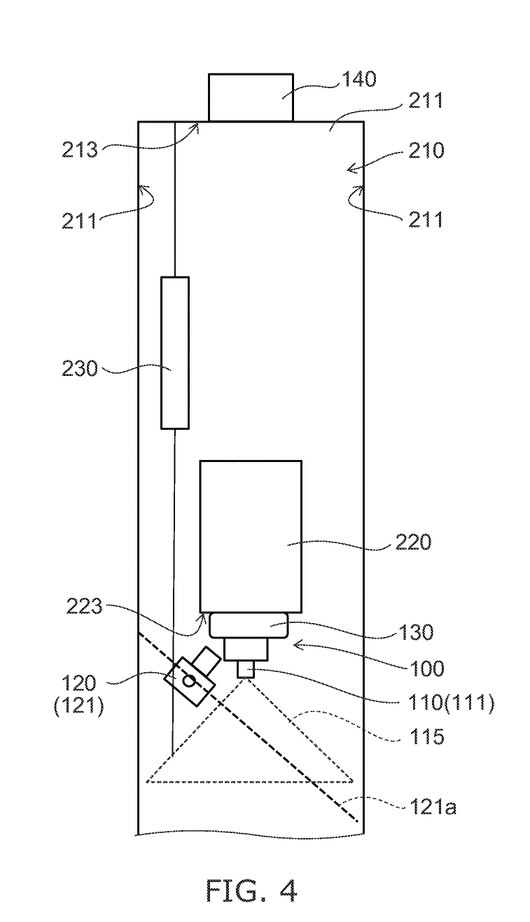

FIG. 4 is a schematic plan view showing a modification of the mounting method of the elevator shaft inner dimension measuring device.

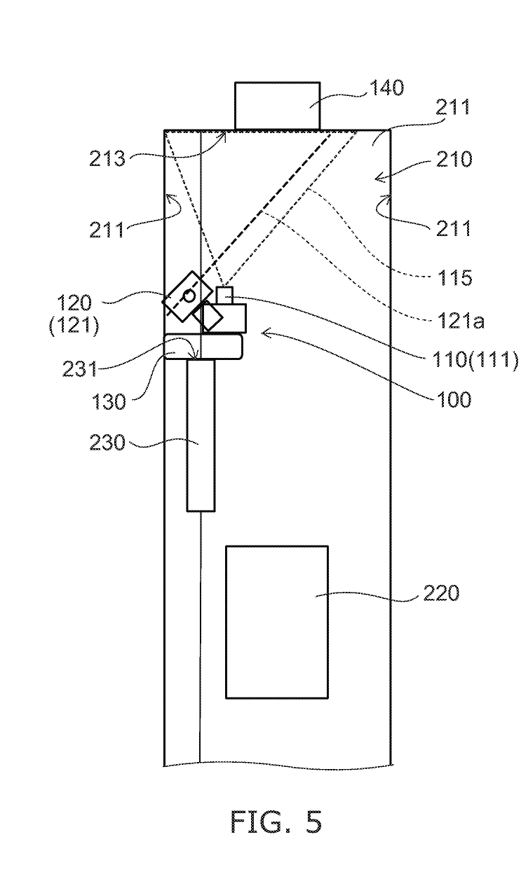

FIG. 5 is a schematic plan view showing another modification of the mounting method of the elevator shaft inner dimension measuring device.

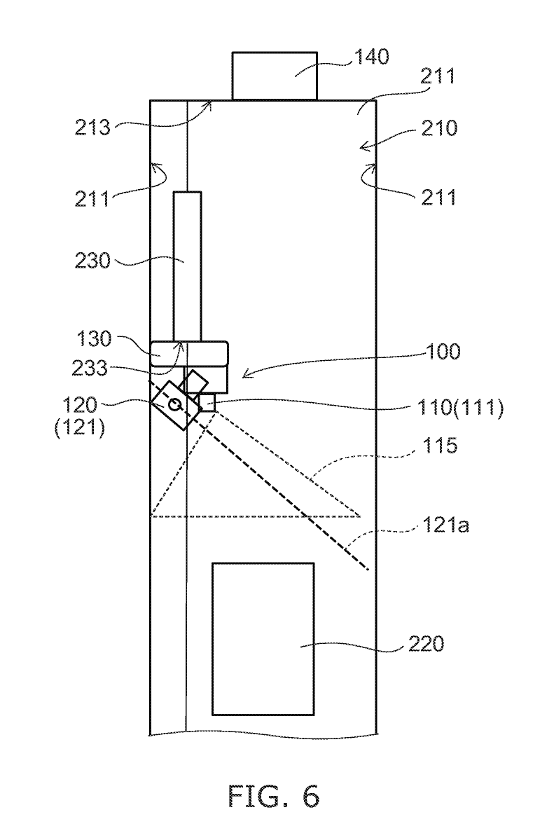

FIG. 6 is a schematic plan view showing another modification of the mounting method of the elevator shaft inner dimension measuring device.

In the example shown in FIG. 4, the elevator shaft inner dimension measuring device 100 is mounted to a lower portion 223 of the elevator car 220. In such a case, the imaging device 110 images the lower range of the elevator shaft 210 from the lower portion 223 of the elevator car 220 in the direction toward the pit (the floor) of the elevator shaft 210.

In the example shown in FIG. 5, the elevator shaft inner dimension measuring device 100 is mounted to an upper portion 231 of the counterweight 230. In such a case, the imaging device 110 images the upper range of the elevator shaft 210 from the upper portion 231 of the counterweight 230 in the direction toward the ceiling 213 of the elevator shaft 210.

In the example shown in FIG. 6, the elevator shaft inner dimension measuring device 100 is mounted to a lower portion 233 of the counterweight 230. In such a case, the imaging device 110 images the lower range of the elevator shaft 210 from the lower portion 233 of the counterweight 230 in the direction toward the pit (the floor) of the elevator shaft 210.

Returning now to FIG. 1 to FIG. 3, the camera included in the imaging device 110 may range from those having constant angles of view to omni-directional cameras that can perform omni-directional imaging in 360 degrees. An omni-directional camera can image the inner wall 211 of the elevator shaft 210 in all directions in 360 degrees around the movement direction of the moving object as an axis. It is desirable for the imaging device 110 to image in the travel direction of the elevator car 220 on which the elevator shaft inner dimension measuring device 100 is mounted. However, it is unnecessary to mount the imaging device 110 to be parallel or perpendicular to the axis of the travel direction of the elevator car 220.

The distance measuring instrument 120 acquires the distance values by measuring the reflected light of the laser light irradiated from the distance measuring instrument 120 (specifically, the first laser rangefinder 121) mounted to the elevator car 220 inside the elevator shaft 210 (step S112).

The first laser rangefinder 121 that is included in the distance measuring instrument 120 scans the laser light irradiated in a relatively narrow range and acquires the distance values between the first laser rangefinder 121 and each position. That is, the first laser rangefinder 121 irradiates the laser light over a prescribed region as in an irradiation region 121a shown in FIG. 3.

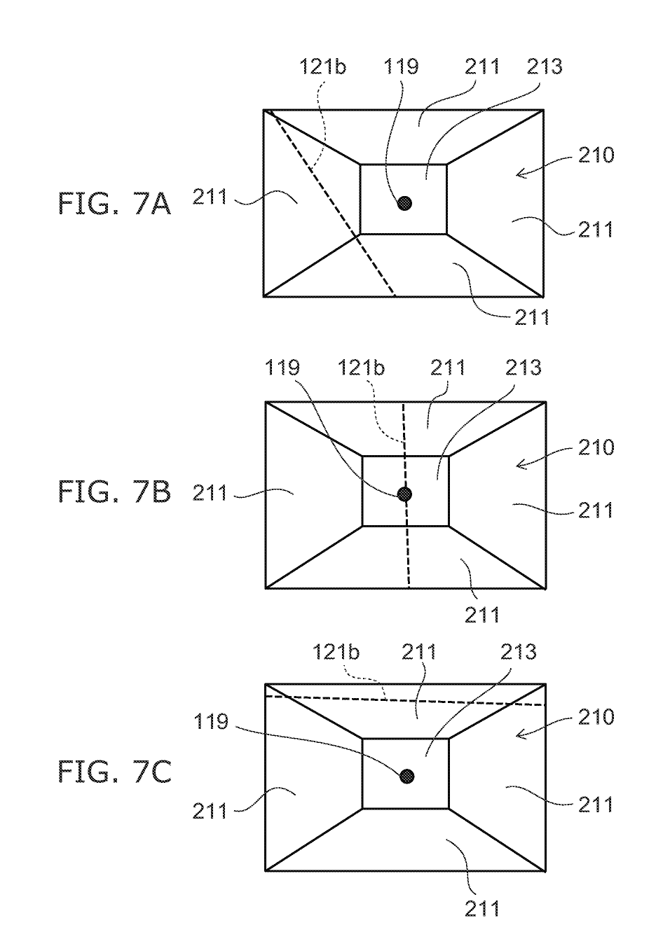

The distance measuring instrument 120 irradiates the laser light at an irradiation angle to shorten the distance (the measurement distance) between the inner wall 211 of the elevator shaft 210 and a projection region 121b of the irradiation region 121a of the laser light projected onto the image that is imaged by the imaging device 110 (referring to FIG. 7A to FIG. 7C) and shorten the distance (pixel units) between the projection region 121b and a center position 119 of the image of the imaging device 110 (the optical center position of the lens, referring to FIG. 7A to FIG. 7C).

This will now be described further with reference to FIG. 7A to FIG. 7C.

FIG. 7A to FIG. 7C are schematic plan views showing examples of the projection region of the irradiation region of the laser light projected onto the image that is imaged.

That is, FIG. 7A to FIG. 7C show examples of the projection region 121b of the irradiation region 121a of the laser light projected onto the image of the interior of the elevator shaft 210.

For example, the examples of the projection onto the image of the projection region 121b of the irradiation region 121a of the laser light irradiated from the first laser rangefinder 121 are as shown in FIG. 7A to FIG. 7C. The irradiation region 121a of the laser light corresponding to the projection region 121b shown in FIG. 7A is different from the irradiation region 121a of the laser light corresponding to the projection region 121b shown in FIG. 7B and FIG. 7C. The irradiation region 121a of the laser light corresponding to the projection region 121b shown in FIG. 7B is different from the irradiation region 121a of the laser light corresponding to the projection region 121b shown in FIG. 7C.

The projection region 121b of the irradiation region 121a of the laser light projected onto the image of the interior of the elevator shaft 210 is more proximal to the center position 119 of the image for the example shown in FIG. 7A than for the example shown in FIG. 7C. The distance (the measurement distance) between the projection region 121b and the inner wall 211 of the elevator shaft 210 is shorter for the example shown in FIG. 7A than for the example shown in FIG. 7B.

The projection region 121b of the irradiation region 121a of the laser light projected onto the image of the interior of the elevator shaft 210 is more proximal to the center position 119 of the image for the example shown in FIG. 7B than for the examples shown in FIG. 7A and FIG. 7C. The distance (the measurement distance) between the projection region 121b and the inner wall 211 of the elevator shaft 210 is longer for the example shown in FIG. 7B than for the examples shown in FIG. 7A and FIG. 7C. That is, the measurement distance is longer for the example shown in FIG. 7B than for the examples shown in FIG. 7A and FIG. 7C because the projection region 121b passes through the ceiling 213 in the image that is imaged.

The projection region 121b of the irradiation region 121a of the laser light projected onto the image of the interior of the elevator shaft 210 is more distal to the center position 119 of the image for the example shown in FIG. 7C than for the examples shown in FIG. 7A and FIG. 7B. The distance (the measurement distance) between the projection region 121b and the inner wall 211 of the elevator shaft 210 is shorter for the example shown in FIG. 7C than for the example shown in FIG. 7B.

One reason that it is better for the projection region 121b of the irradiation region 121a of the laser light projected onto the image of the interior of the elevator shaft 210 to be more proximal to the center position 119 of the image is that, for example, the distortion of the image occurring due to the characteristics of the lens of the imaging device 110 is relatively small at positions relatively proximal to the center position 119 of the image. Thereby, the precision of the position of the elevator car 220 in the interior of the elevator shaft 210 calculated in step S113 shown in FIG. 2 becomes high.

One reason that it is better for the distance (the measurement distance) between the inner wall 211 of the elevator shaft 210 and the projection region 121b of the irradiation region 121a of the laser light projected onto the image of the interior of the elevator shaft 210 to be small is that, for example, the measured intensity of the laser light is relatively high and the reliability is relatively high at positions where the measurement distance of the projection region 121b is relatively short. Thereby, the precision of the position of the elevator car 220 of the interior of the elevator shaft 210 calculated in step S113 shown in FIG. 2 becomes high.

Returning now to FIG. 2, the position calculating device 135 calculates the position of the elevator car 220 inside the elevator shaft 210 by estimating the motion (the rotation and the translation) of the elevator car 220 based on the image data obtained from the imaging device 110 and by acquiring the true scale based on the distance data obtained from the distance measuring instrument 120 (step S113).

The processing of calculating the position of the elevator car 220 inside the elevator shaft 210 based on the image data imaged in step S111 includes first and second processing.

The first processing is executed when two images that are imaged at mutually-different positions are first input to the position calculating device 135 at the start of the processing of calculating the position of the elevator car 220. In the first processing, first, the position calculating device 135 detects feature points between the two images that are imaged at the mutually-different positions and performs a search for the corresponding positions. “Feature point” refers to a characteristic portion inside the image that is imaged by the imaging device 110. If the correspondence of the feature points between the two images can be known, the positions (the translation vectors) of the first camera 111 for when the two images were imaged and the orientations (the rotation matrixes) of the first camera 111 for when the two images were imaged can be determined.

The position of the first camera 111 when the first image is imaged is different from the position of the first camera 111 when the second image is imaged. The orientation of the first camera 111 when the first image is imaged is different from the orientation of the first camera 111 when the second image is imaged.

Continuing, the position calculating device 135 calculates the three-dimensional positions of the feature points by the principle of triangulation based on the correspondence of the feature points, the calculated positions of the first camera 111, and the calculated orientations of the first camera 111.

The second processing is executed when an image that is imaged at a position different from the positions of the two images of the first processing is input to the position calculating device 135 in the state in which the three-dimensional positions of the feature points are known. At this time, the position calculating device 135 estimates the motion of the elevator car 220 based on the positions of the feature points in the image and the three-dimensional positions of the feature points. The position calculating device 135 can estimate the position of the elevator car 220 inside the elevator shaft 210 at each time by repeatedly performing the second processing.

The first processing and the second processing will now be described further.

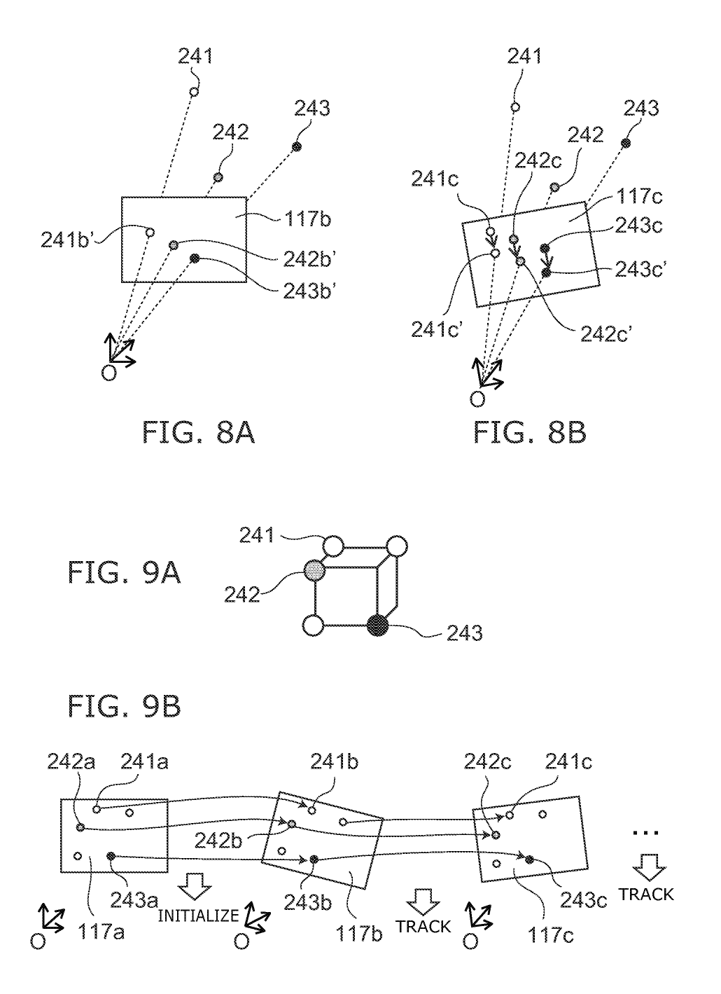

FIG. 8A and FIG. 8B are schematic views showing examples of motion estimation charts of the first camera.

FIG. 9A and FIG. 9B are schematic views showing another example of motion estimation charts of the first camera.

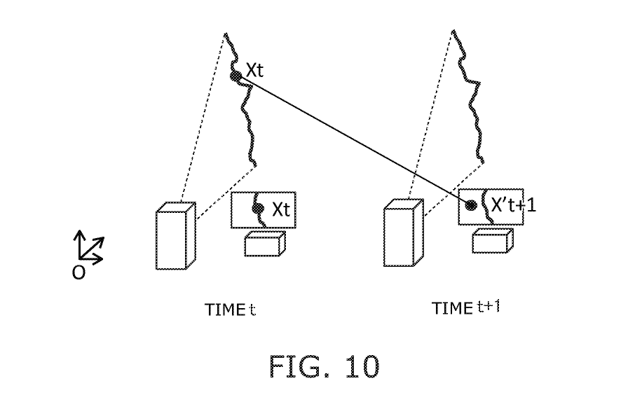

FIG. 10 is a schematic view showing an example of a scale estimation chart of the first laser rangefinder.

In the first processing, the three-dimensional positions of the feature points, the information of the position of the first camera 111, and the information of the orientation of the first camera 111 are unknown. Therefore, first, the position calculating device 135 performs processing to determine the position of the first camera 111 and the orientation of the first camera 111 based on the two images imaged from mutually-different positions. The position calculating device 135 extracts the feature points based on the two images that are the input. It is desirable to suppress the concentration of the feature points in a portion of the image; and it is desirable for the feature points not to be detected within a constant area around the feature points.

Continuing as shown in FIG. 9B, the position calculating device 135 performs a search for the corresponding positions of the feature points between the two images (a first image 117a and a second image 117b). The search for the corresponding positions is performed by setting a relatively small region around the feature points and by evaluating the degree of similarity using SSD (Sum of Squared Difference), etc., based on the luminance pattern of the images. If the correspondence of the feature points between the two images can be known, the positions (the translation vectors) of the first camera 111 for when the two images were imaged and the orientations (the rotation matrixes) of the first camera 111 for when the two images were imaged can be determined.

A first image position 241a is the position on the first image 117a of a first feature point 241. A second image position 242a is the position on the first image 117a of a second feature point 242. A third image position 243a is the position on the first image 117a of a third feature point 243.

A first image position 241b is the position associated with the first image position 241a as a result of the search for the corresponding positions described above. That is, the first image position 241b is the position on the second image 117b of the first feature point 241. A second image position 242b is the position associated with the second image position 242a as a result of the search for the corresponding positions described above. That is, the second image position 242b is the position on the second image 117b of the second feature point 242. A third image position 243b is the position associated with the third image position 243a as a result of the search for the corresponding positions described above. That is, the third image position 243b is the position on the second image 117b of the third feature point 243.

The position of the first camera 111 when the first image (the first image 117a) is imaged is different from the position of the first camera 111 when the second image (the second image 117b) is imaged. The orientation of the first camera 111 when the first image is imaged is different from the orientation of the first camera 111 when the second image is imaged.

The position calculating device 135 determines the three-dimensional positions of the feature points based on the positional relationship of the feature points in the image and the calculated spatial positional relationship of the first camera 111. The initial image (the first image 117a) of the first processing matches the global coordinates at the position of the first camera 111. The rotation matrix is taken to be the identity matrix; and the translation vector is taken to be the zero vector.

The second processing estimates the position of the first camera 111 (the moving object inside the elevator shaft 210) and the orientation of the first camera 111 (the moving object inside the elevator shaft 210) in the state in which the three-dimensional positions of the feature points are determined by the first processing. As shown in FIG. 9B, first, the position calculating device 135 finds feature points in the input image that match the feature points detected by the first processing and forms associations (feature point tracking). In the case where the first camera 111 has not moved greatly from the previous time, the position calculating device 135 may perform the feature point tracking by searching around the feature points found in the image of the previous time.

In the example shown in FIG. 8B, a first image position 241c is the position associated with the first image position 241b as a result of the feature point tracking described above. That is, the first image position 241c is the position on a third image 117c of the first feature point 241. A second image position 242c is the position associated with the second image position 242b as a result of the feature point tracking described above. That is, the second image position 242c is the position on the third image 117c of the second feature point 242. A third image position 243c is the position associated with the third image position 243b as a result of the feature point tracking described above. That is, the third image position 243c is the position on the third image 117c of the third feature point 243.

In the example shown in FIG. 8B, a first projection position 241c′ is the position of the three-dimensional position of the first feature point 241 projected onto the first camera 111 using the position of the first camera 111 and the orientation of the first camera 111 (“′” indicates a projected point). That is, the first projection position 241c′ is the position on the third image 117c of the first feature point 241. A second projection position 242c′ is the position of the three-dimensional position of the second feature point 242 projected onto the first camera 111 using the position of the first camera 111 and the orientation of the first camera 111. That is, the second projection position 242c′ is the position on the third image 117c of the second feature point 242. A third projection position 243c′ is the position of the three-dimensional position of the third feature point 243 projected onto the first camera 111 using the position of the first camera 111 and the orientation of the first camera 111. That is, the third projection position 243c′ is the position on the third image 117c of the third feature point 243.

The position calculating device 135 estimates the position of the first camera 111 and the orientation of the first camera 111 based on the three-dimensional positions of the tracked feature points and the coordinates (the positions) in the image of the feature points. FIG. 8A and FIG. 8B are intuitive illustrations of the processing executed by the position calculating device 135. FIG. 8A and FIG. 8B show the state when the three-dimensional positions are kept the same for the first feature point 241, the second feature point 242, and the third feature point 243, and the position of the first camera 111 and the orientation of the first camera 111 are changed.

In FIG. 8A, the position of the first camera 111 and the orientation of the first camera 111 are correct. FIG. 8A shows that the positions in the image of the feature points that are found match the three-dimensional positions of the feature points projected onto the first camera 111.

In the example shown in FIG. 8A, a first projection position 241b′ is the three-dimensional position of the first feature point 241 projected onto the first camera 111 using the position of the first camera 111 and the orientation of the first camera 111. That is, the first projection position 241b′ is the position on the second image 117b of the first feature point 241. A second projection position 242b′ is the three-dimensional position of the second feature point 242 projected onto the first camera 111 using the position of the first camera 111 and the orientation of the first camera 111. That is, the second projection position 242b′ is the position on the second image 117b of the second feature point 242. A third projection position 243b′ is the three-dimensional position of the third feature point 243 projected onto the first camera 111 using the position of the first camera 111 and the orientation of the first camera 111. That is, the third projection position 243b′ is the position on the second image 117b of the third feature point 243.

In the example shown in FIG. 8B, it can be seen that an error occurs in the projection positions. The position calculating device 135 projects, onto the image based on a rotation matrix R of the first camera 111 and a translation vector t of the first camera 111, the three-dimensional positions of the feature points and the positions in the image of the feature points that are found. The position calculating device 135 estimates the rotation matrix R and the translation vector t so that the difference between the three-dimensional positions of the feature points and the positions in the image of the feature points that are found becomes small. The processing is expressed by the following formula.

$$E ( \hat{R} , \hat{t} ) = {min}_{R , t} {\sum }_{i} {( {x}_{i} - P ( R , t ) {X}_{i} )}^{2} \qquad Formula ( 1 )$$

xᵢ: position in image of ith feature that was found
P(R, t): perspective projection matrix
R: rotation matrix of first camera 111
t: translation vector of first camera 111
Xᵢ: three-dimensional position of feature expressed in homogeneous coordinates

The rotation matrix R and the translation vector t are determined by performing nonlinear optimization to minimize the cost function of Formula (1). Because the movement between adjacent images is not very large, the motion estimation result that is estimated at the previous time can be utilized as the initial value.

However, the scale is indefinite for the translation vector t that is determined. The distance data that is obtained in step S112 is used to cause the scale of the translation vector t to match the actual scale (the true scale).

In the processing of transforming to true scale, first, the projection region 121b of the laser light is tracked in the image. Then, the ratio of the true scale and the camera scale is calculated based on the tracked laser light. Thereby, the scale of the calculated translation vector t is transformed to true scale. As shown in FIG. 10, the tracking of the laser light is the tracking of the points or region of the laser light in the image between images that are imaged at different times. Specifically, for a pixel xt of the image of the first camera 111 where a laser point Xt irradiated at time t is projected, a pixel x′t+1 where the laser point Xt is projected in the image of the first camera 111 at time t+1 is calculated (“′” indicates a tracked point). The three-dimensional position of the tracked pixel x′t+1 can be calculated using the principle of triangulation based on the calculated position (the translation vector t) of the first camera 111 and the calculated orientation (the rotation matrix R) of the first camera 111. Thereby, the scale of the translation vector t can be transformed to true scale by comparing the ratio of the calculated three-dimensional position and the laser point Xt.

Returning now to FIG. 2, the memory device 133 stores the image data obtained in step S111 (step S114). The memory device 133 stores the three-dimensional configuration obtained by transforming the distance data obtained in step S112 into global coordinates (step S114). The transformation of the distance data into global coordinates is performed based on the position of the elevator car 220 and the orientation of the elevator car 220 obtained for each time by the calculation in step S113.

Continuing, the controller 130 determines whether or not to end the processing (step S115). In the case where the controller 130 determines not to end the processing (step S115: No), the processing described above in regard to step S111 to step S114 is executed repeatedly. In the case where the controller 130 determines to end the processing (step S115: Yes), the processing of the elevator shaft inner dimension measuring device 100 ends.

The case where the distance measuring instrument 120 includes the first laser rangefinder 121 is described in the embodiment. However, the number of laser rangefinders included in the distance measuring instrument 120 is not limited thereto. The distance measuring instrument 120 may include two or more laser rangefinders.

This will now be described further with reference to the drawings.

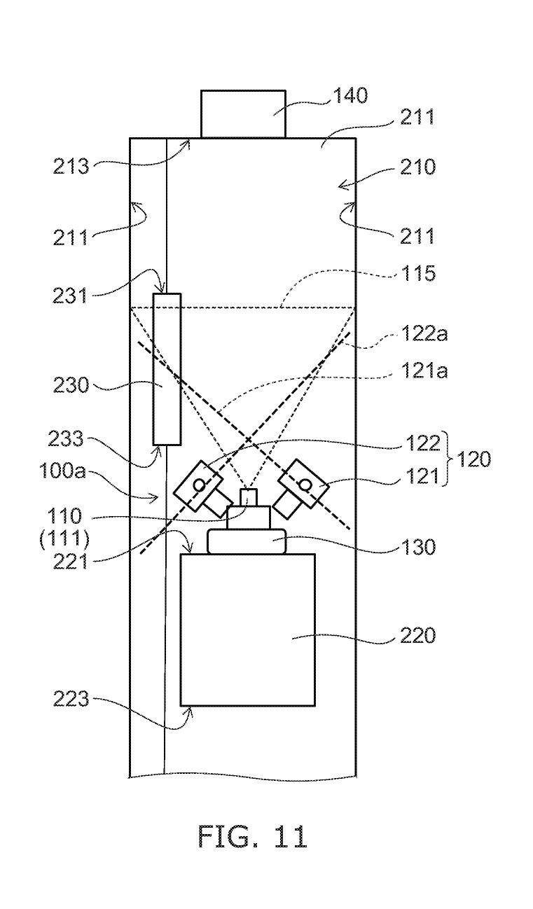

FIG. 11 is a schematic plan view showing an elevator shaft inner dimension measuring device according to another embodiment.

The distance measuring instrument 120 of the elevator shaft inner dimension measuring device 100a shown in FIG. 11 includes the first laser rangefinder 121 and a second laser rangefinder 122. The first laser rangefinder 121 and the second laser rangefinder 122 are mounted to the upper portion 221 of the elevator car 220. The first laser rangefinder 121 irradiates laser light on the irradiation region 121a. The second laser rangefinder 122 irradiates laser light on an irradiation region 122a.

The imaging device 110 is provided between the first laser rangefinder 121 and the second laser rangefinder 122. The moving object to which the elevator shaft inner dimension measuring device 100a is mounted is, for example, the elevator car 220. Or, the moving object to which the elevator shaft inner dimension measuring device 100a is mounted is, for example, the counterweight 230.

It is desirable for the elevator shaft inner dimension measuring device 100a to be mounted to the upper portion 221 of the elevator car 220 or the lower portion 223 of the elevator car 220. It is desirable for the elevator shaft inner dimension measuring device 100a to be mounted to the upper portion 231 of the counterweight 230 or the lower portion 233 of the counterweight 230.

According to the embodiment, the elevator shaft inner dimension measuring devices 100 and 100a measure the position, orientation, and motion of the elevator car 220 or the elevator shaft inner dimension measuring devices 100 and 100a based on the data obtained by the distance measuring instrument 120 and the imaging device 110 imaging the inner wall 211 of the elevator shaft 210. The imaging device 110 and the distance measuring instrument 120 are mounted to the elevator car 220. Thereby, it is unnecessary for the elevator shaft inner dimension measuring devices 100 and 100a to measure the distance between the ceiling 213 and the elevator shaft inner dimension measuring devices 100 and 100a. Moreover, it is unnecessary to mount a roller or a rotary encoder on the guiderail of the elevator. Therefore, the effort to mount the devices is eliminated; and, for example, it is possible to measure the dimensions of the interior of the elevator shaft 210 even in the case where the imaging environment such as the size of the guiderail or the like is different. Thereby, the dimensions of the interior of the elevator shaft 210 can be measured relatively easily or in a relatively short period of time.

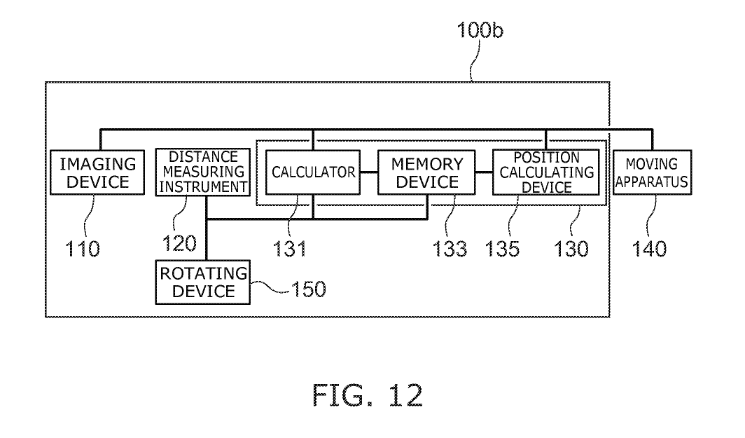

FIG. 12 is a block diagram showing an elevator shaft inner dimension measuring device according to a modification of the embodiment.

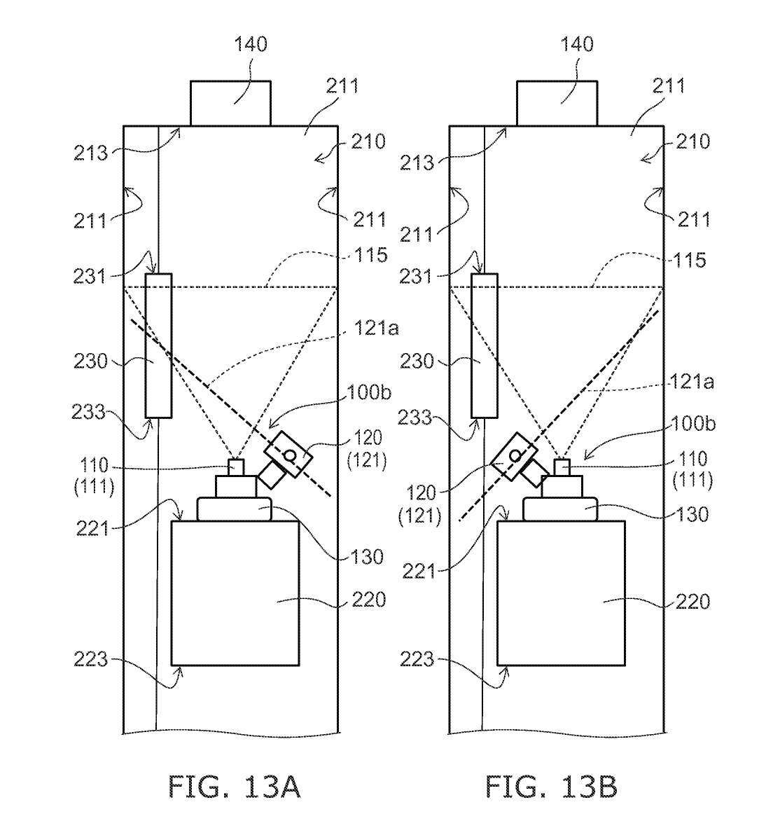

FIG. 13A and FIG. 13B are schematic plan views showing rotation states of the laser rangefinder.

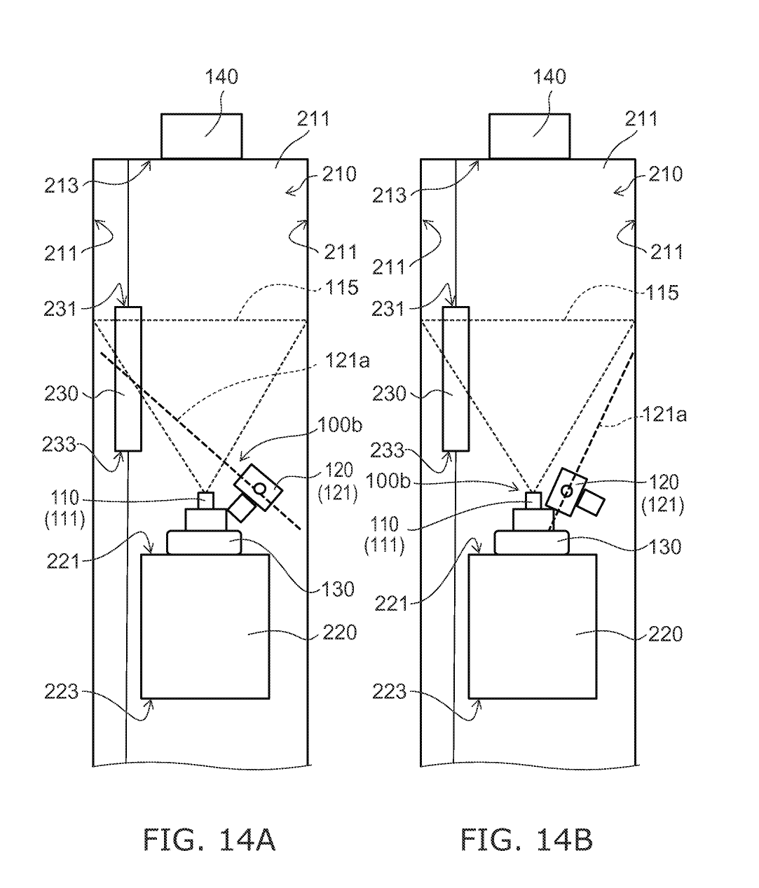

FIG. 14A and FIG. 14B are schematic plan views showing other rotation states of the laser rangefinder.

FIG. 13A and FIG. 14A are schematic plan views showing the position of the laser rangefinder in the outward path of the vertical motion of the elevator car 220. FIG. 13B and FIG. 14B are schematic plan views showing the position of the laser rangefinder in the inward path of the vertical motion of the elevator car 220.

The block diagram shown in FIG. 12 is an example of the relevant components of the elevator shaft inner dimension measuring device according to the embodiment and does not necessarily match the configuration of the actual program module.

In the embodiment described above in regard to FIG. 1, in the case where the distance measuring instrument 120 includes one laser rangefinder (first laser rangefinder 121), the first laser rangefinder 121 cannot measure the elevator shaft 210 in 360 degrees unless the first laser rangefinder 121 has an irradiation angle of 360 degrees. Therefore, compared to the elevator shaft inner dimension measuring device 100 shown in FIG. 1, the elevator shaft inner dimension measuring device 100b shown in FIG. 12 further includes a rotating device 150. The rotating device 150 holds the first laser rangefinder 121.

The elevator shaft inner dimension measuring device 100b modifies the irradiation position of the first laser rangefinder 121 between the outward path of the vertical motion of the elevator car 220 and the inward path of the vertical motion of the elevator car 220 by using the rotating device 150. The first laser rangefinder 121 can measure the interior of the elevator shaft 210 in 360 degrees as the elevator car 220 makes one round trip through the elevator shaft 210. To integrate the measurement data of the first laser rangefinder 121 of the outward path of the vertical motion of the elevator car 220 and the measurement data of the first laser rangefinder 121 of the inward path of the vertical motion of the elevator car 220, the elevator shaft inner dimension measuring device 100b modifies the irradiation angle of the first laser rangefinder 121 using the rotating device 150 while the position of the imaging device 110 is fixed.

In the example shown in FIG. 13A and FIG. 13B, the position of the first laser rangefinder 121 of the outward path is different from the position of the first laser rangefinder 121 of the inward path due to the rotating device 150.

In the example shown in FIG. 14A and FIG. 14B, the position of the first laser rangefinder 121 of the outward path is the same as the position of the first laser rangefinder 121 of the inward path. The angle of the first laser rangefinder 121 of the outward path is different from the angle of the first laser rangefinder 121 of the inward path due to the rotating device 150. That is, in the example shown in FIG. 14A and FIG. 14B, the first laser rangefinder 121 rotates the first laser rangefinder 121 around the optical axis.

In the examples shown in FIG. 13A, FIG. 13B, FIG. 14A, and FIG. 14B, the elevator shaft inner dimension measuring device 100b can modify the irradiation angle of the first laser rangefinder 121 while the position of the imaging device 110 is fixed, that is, while the global coordinate system is fixed. Therefore, the elevator shaft inner dimension measuring device 100b can easily integrate the measurement data of the first laser rangefinder 121 of the outward path and the measurement data of the first laser rangefinder 121 of the inward path.

The global coordinate system moves in the case where the position of the imaging device 110 is rotated by the rotating device 150. Therefore, it is possible to integrate the measurement data of the first laser rangefinder 121 by determining information relating to the rotation angle of the rotating device 150 or the correspondence between the coordinate system prior to the rotation and the coordinate system after the rotation.

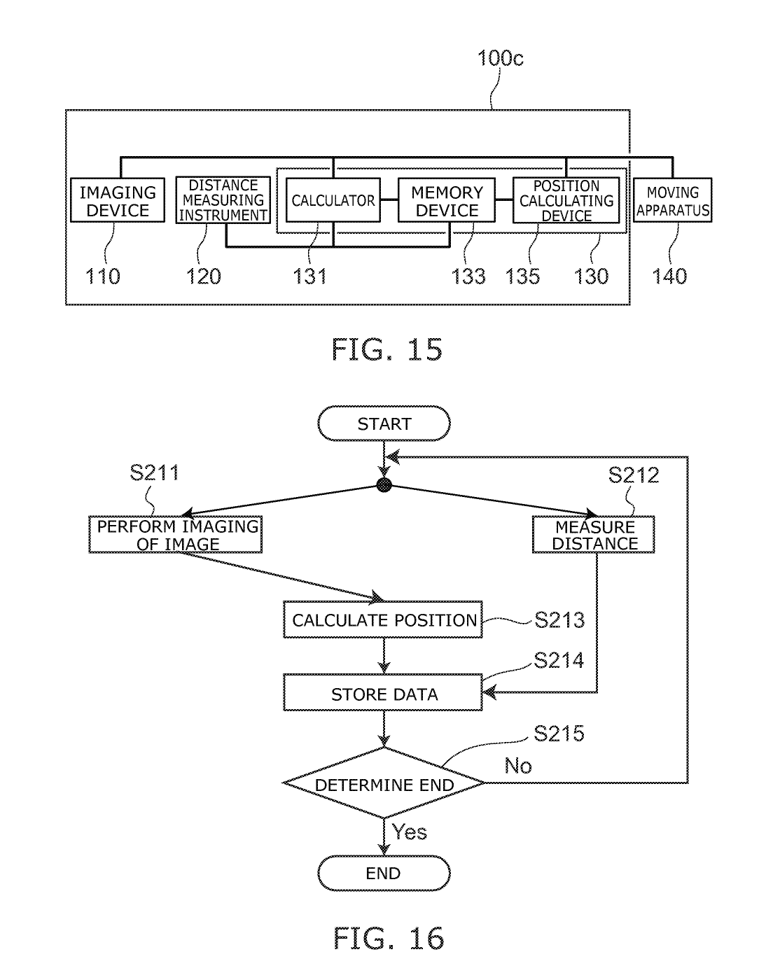

FIG. 15 is a block diagram showing an elevator shaft inner dimension measuring device according to one other embodiment.

FIG. 16 is a flowchart describing an elevator shaft inner dimension measurement method according to the one other embodiment.

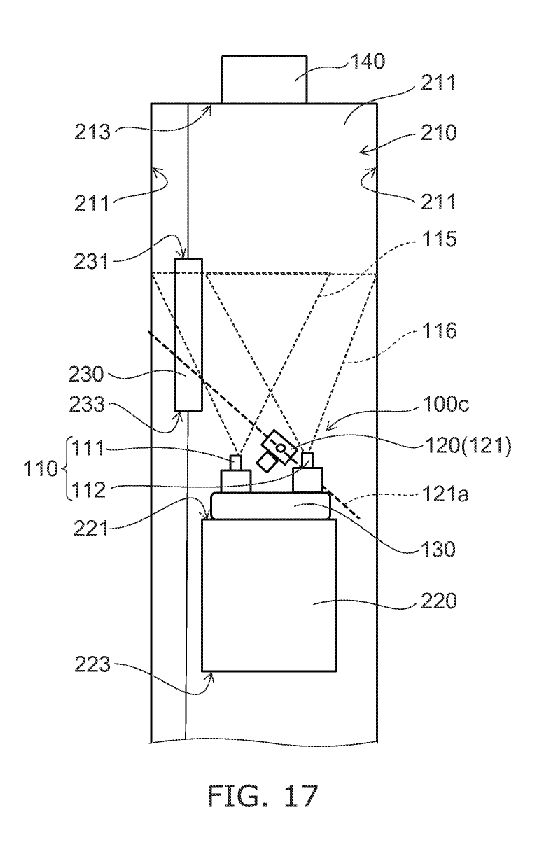

FIG. 17 is a schematic plan view showing the elevator shaft inner dimension measuring device according to the one other embodiment.

The block diagram shown in FIG. 15 is an example of the relevant components of the elevator shaft inner dimension measuring device according to the embodiment and does not necessarily match the configuration of the actual program module.

The elevator shaft inner dimension measuring device 100c according to the embodiment shown in FIG. 15 estimates the motion (the rotation and the translation) of the moving object based on the image data imaged by stereo cameras of the imaging device. The elevator shaft inner dimension measuring device 100c calculates the position of the moving object inside the elevator shaft 210 by acquiring the true scale based on the image data imaged by the stereo cameras of the imaging device.

As shown in FIG. 17, the imaging device 110 includes the first camera 111 and a second camera 112. The first camera 111 and the second camera 112 are mounted to the upper portion 221 of the elevator car 220. The distance measuring instrument 120 is provided between the first camera 111 and the second camera 112. The moving object to which the elevator shaft inner dimension measuring device 100c is mounted is, for example, the elevator car 220. Or, the moving object to which the elevator shaft inner dimension measuring device 100c is mounted is, for example, the counterweight 230.

It is desirable for the elevator shaft inner dimension measuring device 100c to be mounted to the upper portion 221 of the elevator car 220 or the lower portion 223 of the elevator car 220. It is desirable for the elevator shaft inner dimension measuring device 100c to be mounted to the upper portion 231 of the counterweight 230 or the lower portion 233 of the counterweight 230.

Here, an example will be described in which the elevator shaft inner dimension measuring device 100c is mounted to the upper portion 221 of the elevator car 220 as shown in FIG. 17. In other words, an example will be described in which the moving object is the elevator car 220.

As shown in FIG. 16, the imaging device 110 images the range (the first field of view 115) in the travel direction of the elevator car 220 (step S211).

More specifically, the imaging device 110 acquires an image by imaging the interior of the elevator shaft 210 (step S211).

As shown in FIG. 17, the first camera 111 images the first field of view 115. The second camera 112 images a second field of view 116. The first camera 111 is as described above in regard to FIG. 1 to FIG. 3. A digital camera that can receive visible light, a digital camera that can receive infrared light, etc., are examples of the second camera 112. The second field of view 116 and at least a portion of the first field of view 115 overlap.

The calibration of calculating the focal length of the first camera 111, the focal length of the second camera 112, etc., the calibration of calculating the positional relationship (the rotation and the translation) between the first camera 111 and the second camera 112, the calibration of calculating the positional relationship (the rotation and the translation) between the imaging device 110 and the distance measuring instrument 120, etc., are performed beforehand. The calibration method between the first camera 111 and the second camera 112 is, for example, as described in the reference document “Flexible camera calibration by viewing a plane from unknown orientation (IEEE Int. Conf. Computer Vision 1999),” etc.

As shown in FIG. 17, in the case where the elevator shaft inner dimension measuring device 100c is mounted to the upper portion 221 of the elevator car 220, the imaging device 110 images the upper range of the elevator shaft 210 from the upper portion 221 of the elevator car 220 in the direction toward the ceiling 213 of the elevator shaft 210.

The case where the elevator shaft inner dimension measuring device 100c is mounted to the lower portion 223 of the elevator car 220 is as described above in regard to FIG. 4. The case where the elevator shaft inner dimension measuring device 100c is mounted to the upper portion 231 of the counterweight 230 is as described above in regard to FIG. 5. The case where the elevator shaft inner dimension measuring device 100c is mounted to the lower portion 233 of the counterweight 230 is as described above in regard to FIG. 6.

Returning now to FIG. 15 to FIG. 17, it is desirable for the imaging device 110 to image in the travel direction of the elevator car 220 to which the elevator shaft inner dimension measuring device 100c is mounted. However, it is unnecessary for the imaging device 110 to be mounted parallel or perpendicular to the axis in the travel direction of the elevator car 220.

The distance measuring instrument 120 acquires the distance values by measuring the reflected light of the laser light irradiated from the distance measuring instrument 120 (specifically, the first laser rangefinder 121) mounted to the elevator car 220 inside the elevator shaft 210 (step S212).

The distance measuring instrument 120 irradiates the laser light at an irradiation angle to shorten the distance (the measurement distance) between the inner wall 211 of the elevator shaft 210 and the projection region 121b of the irradiation region 121a of the laser light projected onto the image of the imaging device 110 (referring to FIG. 7A to FIG. 7C) and to shorten the distance (pixel units) between the projection region 121b and the center position 119 of the image of the imaging device 110 (the optical center position of the lens, referring to FIG. 7A to FIG. 7C). This is as described above in regard to FIG. 1 to FIG. 3 and FIG. 7A to FIG. 7C.

The position calculating device 135 calculates the position of the elevator car 220 inside the elevator shaft 210 by estimating the motion (the rotation and the translation) of the elevator car 220 based on multiple image data obtained from the imaging device 110 and by acquiring the true scale (step S213). That is, in step S213, the position calculating device 135 calculates the position of the elevator car 220 inside the elevator shaft 210 by estimating the motion (the rotation and the translation) of the elevator car 220 based on the image data imaged by the imaging device 110 in step S211 and by acquiring the true scale based on the positional relationship between the first camera 111 and the second camera 112 calibrated beforehand.

The processing of calculating the position of the elevator car 220 inside the elevator shaft 210 based on the multiple image data imaged in step S211 includes the first and second processing.

The first processing is executed when the image that is imaged by the first camera 111 and the image that is imaged by the second camera 112 are first input to the position calculating device 135 at the start of the processing of calculating the position of the elevator car 220. In the first processing, first, the position calculating device 135 detects the feature points based on the image of the first camera 111 and the image of the second camera 112 and performs a search for the corresponding positions between the image of the first camera 111 and the image of the second camera 112.

Continuing, the position calculating device 135 calculates the three-dimensional positions of the feature points by the principle of triangulation based on the correspondence of the feature points and the positional relationship between the first camera 111 and the second camera 112 calibrated beforehand.

The second processing is executed when the image that is imaged by the first camera 111 and the image that is imaged by the second camera 112 are input to the position calculating device 135 in the state in which the three-dimensional positions of the feature points are known. At this time, the position calculating device 135 estimates the motion of the elevator car 220 based on the three-dimensional positions of the feature points and the positions of the feature points in the image. The position of the elevator car 220 inside the elevator shaft 210 at each time can be estimated by repeatedly performing the second processing.

The first processing and the second processing will now be described further.

In the first processing, the three-dimensional positions of the feature points, the information of the position of the first camera 111, the information of the orientation of the first camera 111, the information of the position of the second camera 112, and the information of the orientation of the second camera 112 are unknown. Therefore, first, the position calculating device 135 performs processing to determine the position of the first camera 111, the orientation of the first camera 111, the position of the second camera 112, and the orientation of the second camera 112 based on the image that is imaged by the first camera 111 and the image that is imaged by the second camera 112. The position calculating device 135 extracts the feature points based on the image of the first camera 111 that is input and the image of the second camera 112 that is input. It is desirable to suppress the concentration of the feature points in a portion of the image; and it is desirable for the feature points not to be detected within a constant area around the feature points.

Continuing, the position calculating device 135 performs a search for the corresponding positions of the feature points between the image of the first camera 111 and the image of the second camera 112. The search for the corresponding positions is performed by setting a relatively small region around the feature points and by evaluating the degree of similarity using SSD (Sum of Squared Difference), etc., based on the luminance pattern of the images. For the first camera 111 and the second camera 112, the relative position between the first camera 111 and the second camera 112 and the relative orientation between the first camera 111 and the second camera 112 are calibrated beforehand.

Therefore, the position calculating device 135 determines the three-dimensional positions of the feature points based on the positional relationship of the feature points between the image of the first camera 111 and the image of the second camera 112, the spatial position of the first camera 111, and the spatial position of the second camera 112. The initial image of the first processing matches the global coordinates at the position of the first camera 111 and the position of the second camera 112. The rotation matrix is taken to be the identity matrix; and the translation vector is taken to be the zero vector.

The second processing estimates the position of the first camera 111 (the moving object inside the elevator shaft 210), the orientation of the first camera 111 (the moving object inside the elevator shaft 210), the position of the second camera 112 (the moving object inside the elevator shaft 210), and the orientation of the second camera 112 (the moving object inside the elevator shaft 210) in the state in which the three-dimensional positions of the feature points are determined by the first processing. First, the position calculating device 135 finds the feature points that match the feature points detected by the first processing for the image of the first camera 111 that is input and the image of the second camera 112 that is input and forms associations (feature point tracking). In the case where the first camera 111 and the second camera 112 have not moved greatly from the previous time, the position calculating device 135 may perform the feature point tracking by searching around the feature points found in the image of the previous time.

The position calculating device 135 estimates the position of the first camera 111, the orientation of the first camera 111, the position of the second camera 112, and the orientation of the second camera 112 based on the three-dimensional positions of the tracked feature points and the coordinates (the positions) in the image of the feature points. Here, for example, the same method as the method described above in regard to FIG. 8A and FIG. 8B is used.

The position calculating device 135 projects, onto the image based on the rotation matrix R for the first camera 111 and the second camera 112 and the translation vector t for the first camera 111 and the second camera 112, the three-dimensional positions of the feature points and the positions in the image of the feature points that are found. The position calculating device 135 estimates the rotation matrix R and the translation vector t so that the difference between the three-dimensional positions of the feature points and the positions in the image of the feature points that are found becomes small. The processing is expressed by the following formula.

$$E ( \hat{R} , \hat{t} ) = {min}_{R , t} {\sum }_{i} {( {x}_{i} - P ( R , t ) {X}_{i} )}^{2} \qquad Formula ( 2 )$$

xᵢ: position in image of ith feature that was found
P(R, t): perspective projection matrix
R: rotation matrix of first camera 111 and second camera 112
t: translation vector of first camera 111 and second camera 112
Xᵢ: three-dimensional position of feature expressed in homogeneous coordinates

The rotation matrix R and the translation vector t are determined by performing nonlinear optimization to minimize the cost function of Formula (2). Because the movement between adjacent images is not very large, the motion estimation result that is estimated at the previous time can be utilized as the initial value.

The scale of the translation vector t that is determined is transformed to true scale based on the positional relationship between the first camera 111 and the second camera 112 calibrated beforehand. Therefore, as in the elevator shaft inner dimension measuring devices 100, 100a, and 100b described above in regard to FIG. 1 to FIG. 14B, it is unnecessary for the position calculating device 135 to acquire the distance data from the distance measuring instrument 120.

The processing of step S214 is the same as the processing of step S114 described above in regard to FIG. 2. The processing of step S215 is the same as the processing of step S115 described above in regard to FIG. 2.

The case where the distance measuring instrument 120 includes the first laser rangefinder 121 is described in the embodiment. However, the number of laser rangefinders included in the distance measuring instrument 120 is not limited thereto. The distance measuring instrument 120 may include two or more laser rangefinders.

This will now be described further with reference to the drawings.

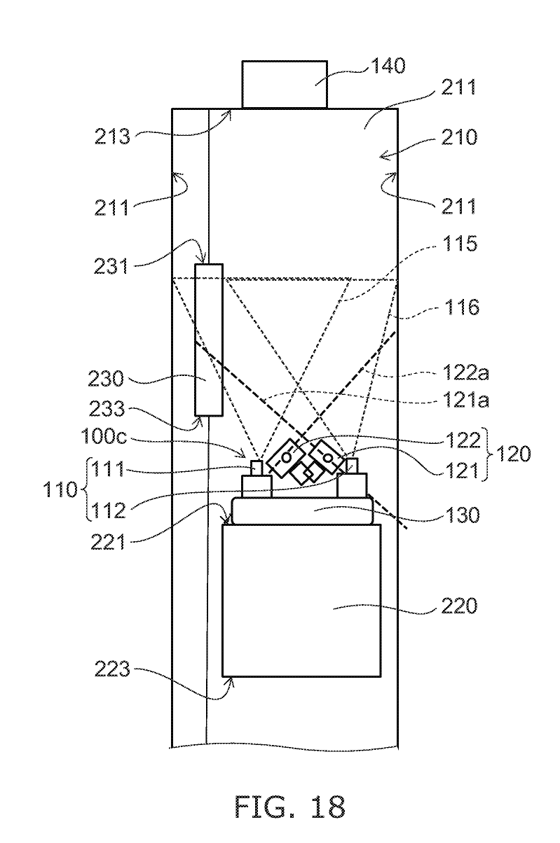

FIG. 18 is a schematic plan view showing an elevator shaft inner dimension measuring device according to another embodiment.

The distance measuring instrument 120 of the elevator shaft inner dimension measuring device 100d shown in FIG. 18 includes the first laser rangefinder 121 and the second laser rangefinder 122. The first laser rangefinder 121 and the second laser rangefinder 122 are mounted to the upper portion 221 of the elevator car 220. The first laser rangefinder 121 irradiates laser light in the irradiation region 121a toward the inside of the first field of view 115 of the first camera 111. The second laser rangefinder 122 irradiates laser light in the irradiation region 122a toward the inside of the second field of view 116 of the second camera 112.

The distance measuring instrument 120 is provided between the first camera 111 and the second camera 112. The moving object to which the elevator shaft inner dimension measuring device 100d is mounted is, for example, the elevator car 220. Or, the moving object to which the elevator shaft inner dimension measuring device 100d is mounted is, for example, the counterweight 230.

It is desirable for the elevator shaft inner dimension measuring device 100d to be mounted to the upper portion 221 of the elevator car 220 or the lower portion 223 of the elevator car 220. It is desirable for the elevator shaft inner dimension measuring device 100d to be mounted to the upper portion 231 of the counterweight 230 or the lower portion 233 of the counterweight 230.

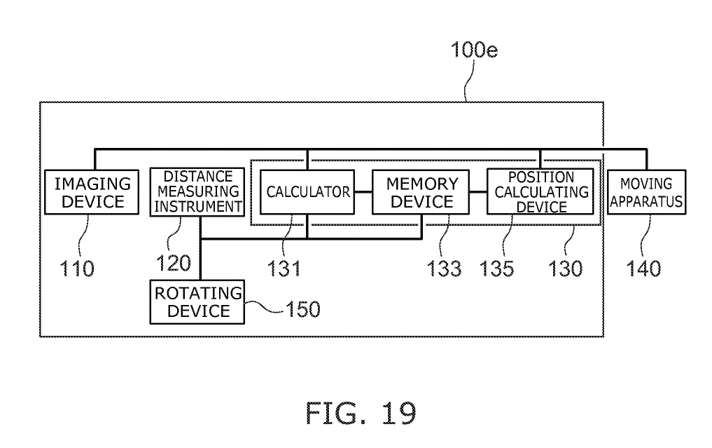

FIG. 19 is a block diagram showing an elevator shaft inner dimension measuring device according to a modification of the embodiment.

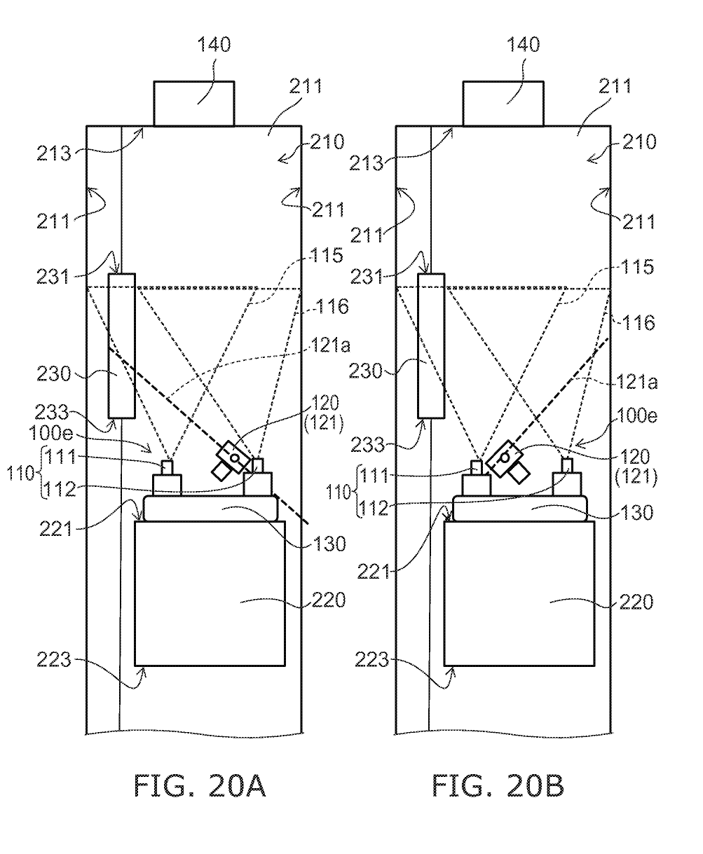

FIG. 20A and FIG. 20B are schematic plan views showing rotation states of the laser rangefinder.

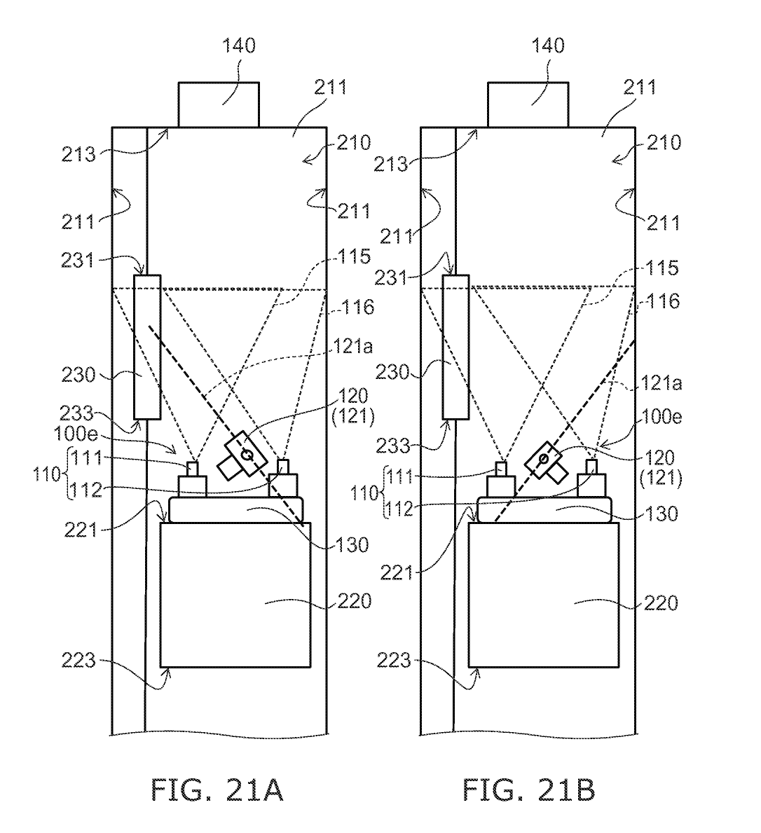

FIG. 21A and FIG. 21B are schematic plan views showing other rotation states of the laser rangefinder.

FIG. 20A and FIG. 21A are schematic plan views showing the position of the laser rangefinder in the outward path of the vertical motion of the elevator car 220. FIG. 20B and FIG. 21B are schematic plan views showing the position of the laser rangefinder in the inward path of the vertical motion of the elevator car 220.

The block diagram shown in FIG. 19 is an example of the relevant components of the elevator shaft inner dimension measuring device according to the embodiment and does not necessarily match the configuration of the actual program module.

In the embodiment described above in regard to FIG. 15, in the case where the distance measuring instrument 120 includes one laser rangefinder (the first laser rangefinder 121), the first laser rangefinder 121 cannot measure the elevator shaft 210 in 360 degrees unless the first laser rangefinder 121 has an irradiation angle of 360 degrees. Therefore, compared to the elevator shaft inner dimension measuring device 100c shown in FIG. 15, the elevator shaft inner dimension measuring device 100e shown in FIG. 19 further includes the rotating device 150.

The elevator shaft inner dimension measuring device 100e modifies the irradiation position of the first laser rangefinder 121 between the outward path of the vertical motion of the elevator car 220 and the inward path of the vertical motion of the elevator car 220 by using the rotating device 150. The first laser rangefinder 121 can measure the interior of the elevator shaft 210 in 360 degrees as the elevator car 220 makes one round trip through the elevator shaft 210. To integrate the measurement data of the first laser rangefinder 121 of the outward path of the vertical motion of the elevator car 220 and the measurement data of the first laser rangefinder 121 of the inward path of the vertical motion of the elevator car 220, the elevator shaft inner dimension measuring device 100e modifies the irradiation angle of the first laser rangefinder 121 using the rotating device 150 while the position of the imaging device 110 is fixed.

In the example shown in FIG. 20A and FIG. 20B, the position of the first laser rangefinder 121 of the outward path is different from the position of the first laser rangefinder 121 of the inward path due to the rotating device 150.

The example shown in FIG. 21A and FIG. 21B, the position of the first laser rangefinder 121 of the outward path is the same as the position of the first laser rangefinder 121 of the inward path. The angle of the first laser rangefinder 121 of the outward path is different from the angle of the first laser rangefinder 121 of the inward path due to the rotating device 150. That is, in the example shown in FIG. 21A and FIG. 21B, the first laser rangefinder 121 rotates the first laser rangefinder 121 around the optical axis.

In the examples shown in FIG. 20A, FIG. 20B, FIG. 21A, and FIG. 21B, the elevator shaft inner dimension measuring device 100e can modify the irradiation angle of the first laser rangefinder 121 while the position of the imaging device 110 is fixed, that is, while the global coordinate system is fixed. Therefore, the elevator shaft inner dimension measuring device 100e can easily integrate the measurement data of the first laser rangefinder 121 of the outward path and the measurement data of the first laser rangefinder 121 of the inward path.

The global coordinate system moves in the case where the position of the imaging device 110 is rotated by the rotating device 150. Therefore, it is possible to integrate the measurement data of the first laser rangefinder 121 by determining information relating to the rotation angle of the rotating device 150 or the correspondence between the coordinate system prior to the rotation and the coordinate system after the rotation.

According to the embodiments, the elevator shaft inner dimension measuring devices 100c, 100d, and 100e measure the position, orientation, and motion of the elevator car 220 or the elevator shaft inner dimension measuring devices 100c, 100d, and 100e based on the data obtained by the distance measuring instrument 120 and the imaging device 110 imaging the inner wall 211 of the elevator shaft 210. The imaging device 110 and the distance measuring instrument 120 are mounted to the elevator car 220. Thereby, it is unnecessary for the elevator shaft inner dimension measuring devices 100c, 100d, and 100e to measure the distance between the ceiling 213 and the elevator shaft inner dimension measuring devices 100c, 100d, and 100e. Moreover, it is unnecessary to mount a roller or a rotary encoder on the guiderail of the elevator. Therefore, the effort to mount the devices is eliminated; and, for example, it is possible to measure the dimensions of the interior of the elevator shaft 210 even in the case where the imaging environment such as the size of the guiderail or the like is different.

The imaging device 110 of the elevator shaft inner dimension measuring devices 100c, 100d, and 100e includes the first camera 111 and the second camera 112. Therefore, the scale of the translation vector t is transformed to true scale based on the positional relationship between the first camera 111 and the second camera 112 calibrated beforehand. Thereby, the position calculating device 135 can calculate the position of the elevator car 220 inside the elevator shaft 210 without acquiring the distance data from the distance measuring instrument 120 by acquiring the true scale based on the positional relationship between the first camera 111 and the second camera 112 calibrated beforehand. Thereby, the dimensions of the interior of the elevator shaft 210 can be measured relatively easily or in a relatively short period of time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An elevator shaft inner dimension measuring device, comprising:
a distance measuring instrument including a first laser rangefinder mounted to a moving object moving through an interior of an elevator shaft, the first laser rangefinder irradiating laser light on an inner wall of the elevator shaft;
an imaging device including a first camera mounted to the moving object, the first camera imaging the interior of the elevator shaft; and
a controller including a calculator, a position calculating device, and a memory device,
the calculator performing an operation on distance data and image data, the distance data being obtained from the distance measuring instrument, the image data being obtained from the imaging device,
the position calculating device estimating a motion of the moving object based on the image data and calculating a position of the moving object in the interior of the elevator shaft based on the distance data,
the memory device storing the distance data and the image data.

2. The device according to claim 1, wherein the first laser rangefinder irradiates the laser light toward the inside of an imaging range of the first camera.

3. The device according to claim 1, wherein the moving object is an elevator car moving through the elevator shaft in two directions.

4. The device according to claim 1, wherein the moving object is a counterweight moving through the elevator shaft in two directions.

5. The device according to claim 1, wherein the distance measuring instrument sets an irradiation angle of the laser light based on a distance between a projection region and a center position of an image and based on a distance between the projection region and the inner wall, the image being imaged by the imaging device, the projection region being an irradiation region of the laser light projected onto the image.

6. The device according to claim 1, wherein the position calculating device calculates the position of the moving object in the interior of the elevator shaft by acquiring a true scale of the motion based on the distance data.

7. The device according to claim 1, wherein the first camera is an omni-directional camera capable of imaging the inner wall in 360 degrees around an axis of a movement direction of the moving object.

8. The device according to claim 1, wherein the imaging device further includes a second camera mounted to the moving object, the second camera imaging the interior of the elevator shaft.

9. The device according to claim 8, wherein an imaging range of the second camera and at least a portion of an imaging range of the first camera overlap.

10. The device according to claim 8, wherein
a positional relationship between the first camera and the second camera is calibrated, and
the position calculating device calculates the position of the moving object in the interior of the elevator shaft by acquiring a true scale of the motion based on the calibrated positional relationship.

11. The device according to claim 1, further comprising a rotating device holding the first laser rangefinder and modifying an irradiation angle of the laser light.

12. The device according to claim 11, wherein the rotating device modifies a position of the first laser rangefinder or an angle of the first laser rangefinder while a position of the imaging device is fixed.

13. The device according to claim 1, wherein the distance measuring instrument further includes a second laser rangefinder mounted to the moving object, the second laser rangefinder irradiating laser light on the inner wall of the elevator shaft.

14. The device according to claim 1, wherein the first camera is a digital camera capable of receiving visible light or infrared light.

15. An elevator shaft inner dimension measurement controller, comprising:
a calculator performing an operation on distance data and image data, the distance data being obtained from a distance measuring instrument including a laser rangefinder mounted to a moving object moving through an interior of an elevator shaft, the laser rangefinder irradiating laser light on an inner wall of the elevator shaft, the image data being obtained from an imaging device including a first camera mounted to the moving object, the first camera imaging the interior of the elevator shaft;
a position calculating device estimating a motion of the moving object based on the image data and calculating a position of the moving object in the interior of the elevator shaft based on the distance data; and
a memory device storing the distance data and the image data.

16. The controller according to claim 15, wherein the position calculating device calculates the position of the moving object in the interior of the elevator shaft by acquiring a true scale of the motion based on the distance data.

17. The controller according to claim 15, wherein
the imaging device further includes a second camera mounted to the moving object, the second camera imaging the interior of the elevator shaft,
a positional relationship between the first camera and the second camera is calibrated, and
the position calculating device calculates the position of the moving object in the interior of the elevator shaft by acquiring a true scale of the motion based on the calibrated positional relationship.

18. An elevator shaft inner dimension measurement method, comprising:
performing an operation on distance data and image data, the distance data being obtained from a distance measuring instrument including a laser rangefinder mounted to a moving object moving through an interior of an elevator shaft, the laser rangefinder irradiating laser light on an inner wall of the elevator shaft, the image data being obtained from an imaging device including a first camera mounted to the moving object, the first camera imaging the interior of the elevator shaft;
estimating a motion of the moving object based on the image data and calculating a position of the moving object in the interior of the elevator shaft based on the distance data; and
storing the distance data and the image data.

19. The method according to claim 18, including calculating the position of the moving object in the interior of the elevator shaft by acquiring a true scale of the motion based on the distance data.

20. The method according to claim 18, wherein
the imaging device further includes a second camera mounted to the moving object, the second camera imaging the interior of the elevator shaft,
a positional relationship between the first camera and the second camera is calibrated, and
the position of the moving object in the interior of the elevator shaft is calculated by acquiring a true scale of the motion based on the calibrated positional relationship.
